(19) United States
(12) Patent Application Publication
(10) Pub. No.: US 2022/0389277 A1
(43) Pub. Date: Dec. 8, 2022

(54) SYSTEM AND METHODS OF FINISHING A METALLIC SURFACE

(71) Applicant: 3M INNOVATIVE PROPERTIES COMPANY, St. Paul, MN (US)

(72) Inventors: Andrew R. Henry, Hudson, WI (US); Philip S. Hill, Woodbury, MN (US)

(21) Appl. No.: 17/755,028

(22) PCT Filed: Oct. 21, 2020
(86) PCT No.: PCT/IB2020/059902

§ 371 Date: Apr. 19, 2022

Related U.S. Application Data
(60) Provisional application No. 62/926,830, filed on Oct. 28, 2019.

(51) Int. Cl. C09G 1/02; C09K 3/14; B24B 31/112

(52) U.S. Cl. CPC C09G 1/02; C09K 3/1463; B24B 31/112

(57) ABSTRACT

An abrasive solution for finishing a metal part is provided. The abrasive solution includes abrasive particles suspended in a solution. The abrasive particles are configured to abrade a surface of the metal part. The abrasive particles are substantially non-responsive to a magnetic field. The abrasive solution also includes magnetic particles suspended in the solution. The magnetic particles are configured to respond to a magnetic field by aggregating together such that a local flow pattern of the solution changes in response to the aggregated magnetic particles.

### BACKGROUND

3-D printing processes generally result in part bodies having a rough surface finish. As used herein, the term “3-D printed” refers to an additive manufacturing process (e.g., laser sintering or powder jet printing) in which layers of powder particles (e.g., metal powder particles) are sequentially deposited.

In many cases, 3-D printed metal bodies have complex shapes with internal surfaces that make them poor candidates for abrasive surface finishing techniques. Accordingly, chemical-etching has been considered. However, this technique has limitations such as the tendency of the etchant to etch deeply into surface pores, rather than just etching raised portions of the surface. Electropolishing is also a possibility, but is generally not suitable for finishing internal surfaces and rounded corners. As a result, good smoothness is difficult to impossible using current methods.

### SUMMARY

The present disclosure overcomes the above deficiency of etching methods, and provides a method capable of finishing metal surfaces that have improved smoothness as compared to prior etching methods of surface finishing.

An abrasive solution for finishing a metal part is provided. The abrasive solution includes abrasive particles suspended in a solution. The abrasive particles are configured to abrade a surface of the metal part. The abrasive particles are substantially non-responsive to a magnetic field. The abrasive solution also includes magnetic particles suspended in the solution. The magnetic particles are configured to respond to a magnetic field by aggregating together such that a local flow pattern of the solution changes in response to the aggregated magnetic particles.

### BRIEF DESCRIPTION OF THE DRAWINGS

FIGS. 1A-1B illustrates examples of metal parts formed from additive manufacturing prior to a finishing operation.

FIG. 2 illustrates an example system for finishing a metal part in accordance with an embodiment of the present invention.

FIGS. 3A-3C illustrate the formation of magnetic guide vanes in accordance with embodiments of the present invention.

FIGS. 4A-4C illustrate the effects of magnetic guide vanes on the finishing of a metal part in accordance with embodiments of the present invention.

FIG. 5 illustrates another example system for finishing a metal part in accordance with an embodiment of the present invention.

FIG. 6 illustrates an example abrasive suspension in accordance with embodiments of the present invention.

FIG. 7 illustrates an example system for modulating a magnetic guide vane in accordance with an embodiment of the present invention.

FIG. 8 illustrates a method for finishing a metal component in accordance with an embodiment of the present invention.

FIG. 9 illustrates another method for finishing a metal component in accordance with another embodiment of the present invention.

FIGS. 10-11 illustrate systems discussed in greater detail in the Examples.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Metal additive manufacturing technologies now exist that are capable of producing components in many of the widely used engineering alloys, including stainless steels, cobalt-chrome alloys, titanium alloys; most notably Ti-6A1-4V, nickel based super alloys and aluminum alloys. These parts are manufactured without many of the constraints of traditional machining/casting methods. Complex geometry to enable weight reduction, performance improvement and combining parts into single assemblies are possible through additive manufacturing techniques.

Due to the method involved, rapid prototyping methods such as laser powder sintering and powder jet printing (following by sintering) result in sintered metal bodies having a sintered metallic surface comprising sintered metal powder particles and crevices (and/or peaks). Details concerning laser sintering can be found in, for example, U.S. Pat. No. 4,938,816 (Beaman et al.); U.S. Pat. No. 5,155,324 (Deckhard et al.); and U.S. Pat. No. 5,733,497 (McAlea). Details concerning powder jet printing techniques can be found, for example, in U.S. Pat. No. 5,340,656 (Sachs et al.); U.S. Pat. No. 6,403,002 B1 (van der Geest); and U. S. Pat. Appl. Publ. No. 2018/0126515 (Franke et al.).

However, the geometrical complexity available can cause a ‘line of sight’ problem whereby it is difficult for a conventional coated or bonded abrasive to access all surfaces to be finished. Accordingly there is a growth in the adoption of ‘mass finishing’ techniques for finishing metal additive manufactured components, such as vibratory finishing, for example. However, with complex parts, these techniques are best for external surfaces, and are likely to miss hard-to-reach areas such as recesses and internal channels. These processes cannot be targeted to finish a particular surface and can over-finish some areas to achieve the required properties of another area.

A finishing option is desired for surface finishing of the complex surface or internal geometries to improve the mechanical properties, particularly fatigue rates. The finishing option should be able to target specific areas for necessary finishing without over-finishing other areas.

Different systems and methods for finishing these surfaces have been attempted. For example, an abrasive liquid with magnetically responsive abrasive particles can be forced to move past a printed part using movement of a magnetic field. Alternatively, the viscosity of a magnetically responsive fluid can be increased in order to increase the cut rate of abrasive particles passing over a part surface.

Magneto-rheological finishing (MRF) is generally used in industry for the precision polishing of optical components. This technique uses a high concentration of magnetic iron within an oil formulation. The fluid is then controlled in real time using the magnetic field to control the material removal rate. In the current field of Magneto-Rheological Finishing (MRF) the magnetic component (typically iron) is suspended in the fluid in a high proportion and acts as part of the fluid. The iron particles may be less than 10 μm or up to 500 μm.

Embodiments described herein, in contrast, cause removal of magnetic particles from an abrasive suspension, using the magnet. The magnetic particles are gathered together in a position dictated by placement of the magnet. The shape formed causes disruption to the flow of an abrasive fluid pumped through a vessel used for finishing. By manipulating part orientation, the form of the gathered iron particles, and fluid velocity, a targeted stream of abrasive fluid can be directed against a specified part geometry, allowing for targeted finishing.

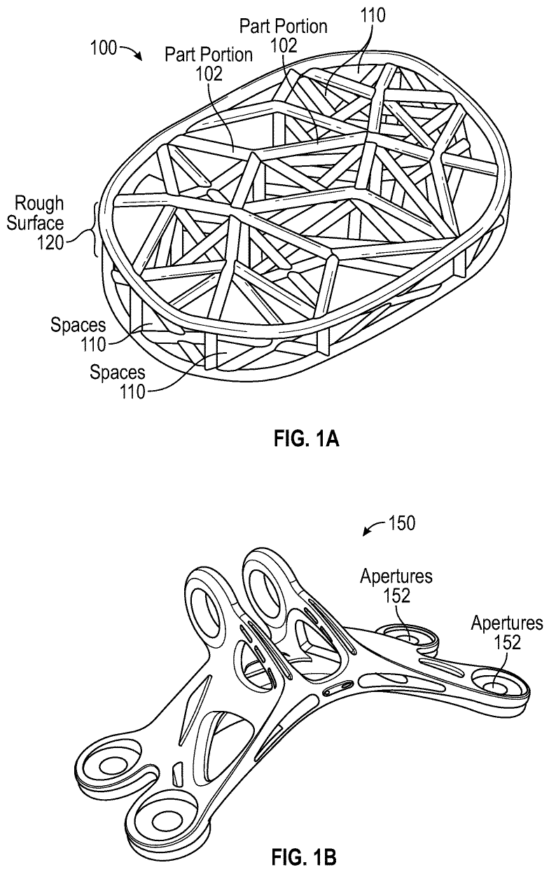

FIGS. 1A-1B illustrates examples of metal parts formed from additive manufacturing prior to a finishing operation. Metal parts 100 and 150 can be formed using any one of several different additive manufacturing techniques. However, while additive manufacturing can create parts 100 and 150 with metal portions 102, internal spaces 110 and apertures 152, it can also result in a rough surface 120 of those components. The presence of rough surface 120 can result in fatigue and other weakness of the part.

Therefore, it is important to have systems and methods that can facilitate finishing of parts 100 and 150 to remove surface roughness 120. Because of the difficulty for traditional systems and methods to maneuver around part portions 102, get into internal spaces 110 and through apertures 152, new systems and methods for targeted finishing are needed.

While parts 100 and 150 are shown, other exemplary metal components needing finishing include medical devices (e.g., artificial joints), architectural and/or ornamental castings, engine components parts, turbine blades, propellers. Additionally, while systems and methods described herein may be particularly useful for metal parts with complex geometries, it is also envisioned that they may be useful for any part with a metal surface needing finishing.

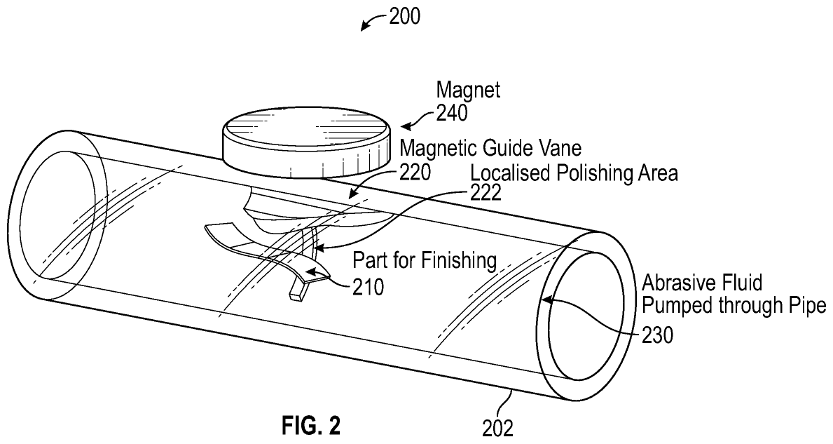

FIG. 2 illustrates an example system for finishing a metal part in accordance with an embodiment of the present invention. System 200 is a continuous flow system with a pipe 202, within which a part 210 is mounted for finishing. However, similar concepts could also be applied to a batch system in another embodiment. An abrasive fluid 230 is pumped through pipe 202. Abrasive fluid 230 contains abrasive particles in suspension within a solvent, such as an oil-based, aqueous, or other suitable solvent. Abrasive fluid 230 has a viscosity and is pumped through pipe 202 at a constant rate, in one embodiment.

Abrasive fluid 230 also contains magnetic particles in suspension. In the presence of a magnet 240, the magnetic particles come together to form a magnetic guide vane 220 that alters the flow behavior of abrasive fluid 230 through pipe 202. While a physical magnet 240 is illustrated as positioned outside of, but parallel to a direction of flow within a pipe, other configurations are also expressly contemplated. For example, an electromagnetic field may be used instead of magnet 240. Additionally, magnet 240 may be positioned differently. For example, magnet 240 may be configured to move along a surface of pipe 202, causing magnetic guide vane 220 to dynamically change shapes. Additionally, magnet 240 could be built into pipe 202. Other configurations are also envisioned.

The shape and size of magnetic guide vane 220 is affected by a number of factors. The quantity of magnetic particles in suspension within abrasive fluid 230 affects the amount of magnetic material available to form magnetic guide vane 220. Additionally, size and placement of magnet 240 can affect the shape that magnetic guide vane 220 forms within pipe 202 by altering the magnetic field position and strength. The flow rate of the abrasive suspension can also change the shape of magnetic guide vane 220.

Magnetic guide vane 220 causes the flow behavior of abrasive fluid 230 to change, such that it is directed to a local area 222 on metal part 210 for focused abrasive activity. Altering the position, size and shape of magnetic guide vane 220 causes a position of localized polishing area 222 to change. Controlling how a position of magnet 240 changes along the surface of pipe 202, and the strength of the resulting magnetic field, for example by moving magnet 240 closer to, or further from, the surface of pipe 202, allows for predictable movement of local area 222 for targeted finishing of the surface of metal part 210. While FIG. 2 illustrates a simple configuration with a single magnet 240, it is expressly envisioned that, in some embodiments, multiple magnets can be used, and their position and strength modulated so that localized polishing area 222 moves predictably about a part being finished within a system 200.

For example, 3D printed parts have an associated CAD file, STL file, or other design file used for designing and printing the part. Based on such a file, it is expressly contemplated that system 200 can incorporate an automated process for modulating one or more magnets 240 such that the entire structure of part 210 can be evenly finished. For example, a geometry file can be used to predict fluid flow using computational fluid dynamic techniques. This could be done automatically, for example, based on a received design file for part 210 and an intended position of part 210 with system 200.

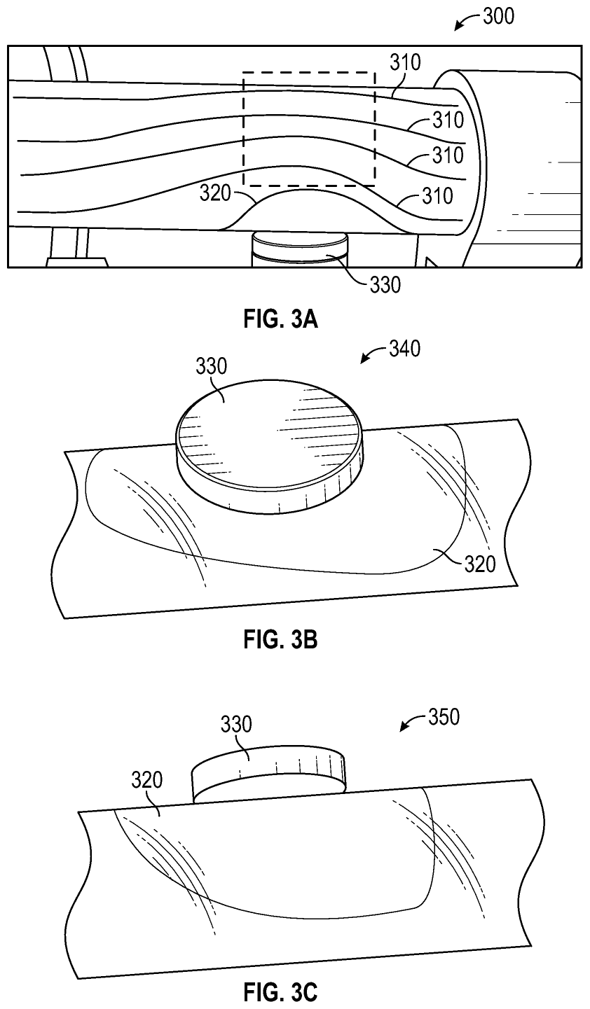

FIGS. 3A-3C illustrate the formation of magnetic guide vanes in accordance with embodiments of the present invention. FIGS. 3A-3C illustrate a continuous flow system 300 comprising a pipe through which an abrasive suspension containing magnetic particles in suspension flows. In response to a magnetic force, provided by a magnet 330 positioned next to the pipe, magnetic particles 320 agglomerate along an inner surface of system 300, creating a magnetic guide vane. As illustrated in FIG. 3A, a flow profile 310 of the abrasive fluid changes in response to the formation of the magnetic guide vane. FIGS. 3B and 3C illustrate a top view and a close-up view, respectively, showing the interaction between magnet 330 and magnetic particles 320.

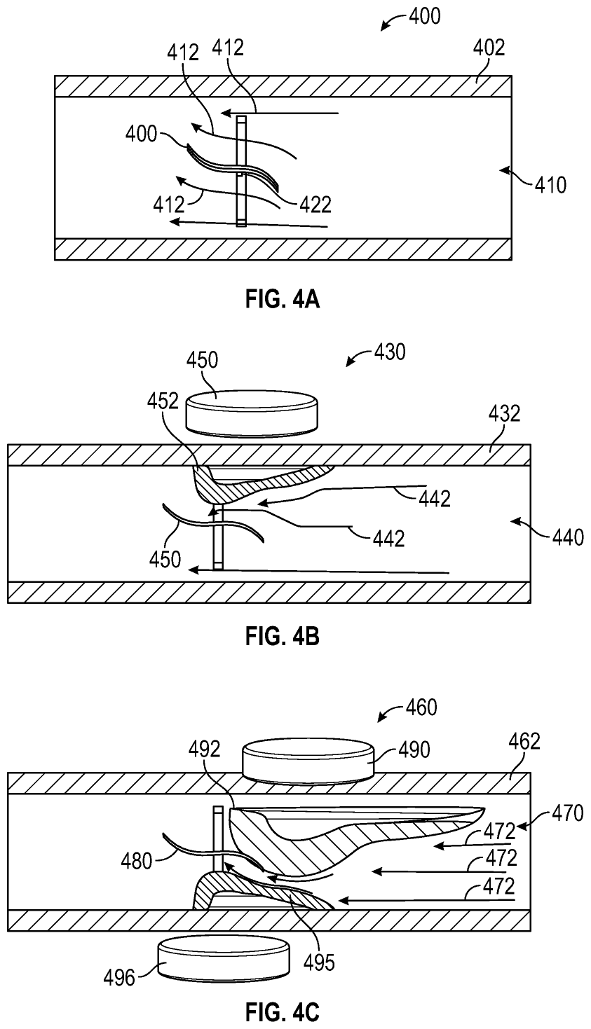

FIGS. 4A-4C illustrate the effects of magnetic guide vanes on the finishing of a metal part in accordance with embodiments of the present invention. FIG. 4A illustrates a continuous flow system 400 that includes a tube 402 through which a fluid 410 flows around a metal part 420. As illustrated in FIG. 4A, fluid flows around part 420 according to fluid flow pattern 412. Metal part 420 may be mounted within tube 402 using a mount 422. Mount 422 may cause metal part 420 to remain in a stationary position during a finishing operation, in one embodiment. However, in another embodiment, mount 422 can cause metal part 420 to rotate or move within tube 402, allowing for additional flexibility in a finishing operation.

FIG. 4B illustrates a system 430 with a magnet 450. Magnet 450 causes magnetic particles to aggregate on a side of pipe 432, forming magnetic guide vane 452. Guide vane 452 causes fluid flow of abrasive fluid 440 to change, as indicated by fluid flow lines 442, such that abrasive fluid 440 is targeted to a localized area of metal part 450, which is mounted within pipe 532.

FIG. 4C illustrates a system with two magnets, 490 and 496. As discussed above, it is expressly contemplated that some embodiments of the present invention include multiple magnets or sources of magnetic fields located proximate a metal part 480 during a finishing operation. Magnets 490 and 496 are illustrated as similar in size. However, it is expressly contemplated that a multi-magnet system may have magnets of different strengths, for example by using different sized magnets or by using electromagnets. Additionally, the strength of the magnetic field provided by magnets 490, 496 can be altered by moving magnets 490, 496 closer to, or further away from, pipe 462. Each of magnets 490, 496 causes magnetic guide vanes 492, 495 respectively, to form on an internal surface of pipe 462. Magnetic guide vanes 492, 495 cause local flow of abrasive fluid 470 around metal part 480 to change, as indicated by flow lines 472. Manipulating the size and position of magnetic guide vanes 492, 495 can cause local flow of abrasive fluid 470 to change further. In some embodiments, a controller (not shown) causes magnets 490, 496 to change position along tube 462 and/or a distance away from tube 462 in order to control the shape and position of magnetic guide vanes 492, 495. The controller can, therefore, control the local flow of abrasive fluid 470, targeting areas of part 480 that need finishing. The controller can function automatically, for example based on known specifications of part 480 (e.g. from a CAD model or STL file associated with part 480), manipulate magnets 490, 496 to direct flow to areas needing finishing. The controller can also automatically calculate flow paths around part 480, using computational fluid dynamics, and calculate appropriate changes to magnetic position to modify guide vanes 492, 495 accordingly. In some embodiments, the controller may also receive input concerning roughness of part 480, or portions of part 480, after a manufacturing step, and create a finishing routine accordingly.

While magnets 490 and 496 are illustrated as stationary magnets, it is contemplated that, in some embodiments, they are configured to move during a finishing operation. If magnets 490, 496 move during a finishing operation, flow 472 of abrasive fluid 470 can be targeted toward different surfaces of metal part 480. Additionally, while only two magnets 490, 496 are illustrated, it is also envisioned that, in some embodiments, more than two magnets are present, such as three, four, five or more. Further, while magnets are illustrated, it is also expressly contemplated that a magnetic field can be generated using other suitable mechanisms, such as electromagnetic technology.

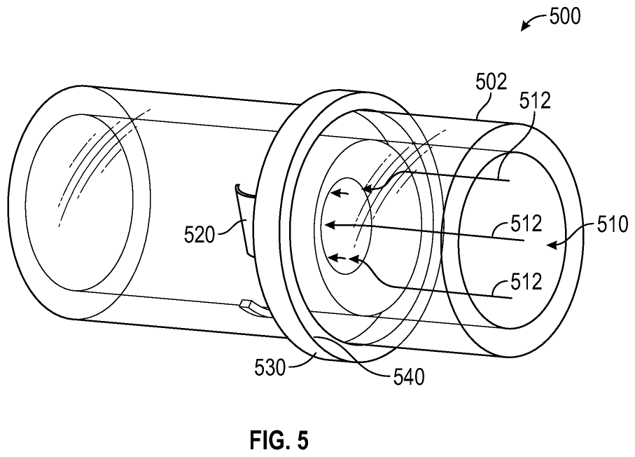

FIG. 5 illustrates another example system for finishing a metal part in accordance with an embodiment of the present invention. While magnets targeting a single position on a finishing system have been discussed, other types and configurations of magnets are also envisioned. For example, in system 500, a ring-shaped magnet 530 is illustrated, which causes a magnetic guide ring 540 to form on an interior side of pipe 502, effectively reducing a diameter of pipe 502. Abrasive fluid 510 is forced to flow through guide ring 540, which changes flow pattern 512. Magnetic guide rings 540 may be useful to change the velocity of abrasive fluid 510 as it moves through pipe 502 and interacts with metal part 520 mounted within pipe 502. Additionally, if a strength of magnetic guide ring 540 varies along its circumference, the flow pattern 512 can vary even more, for example causing faster flow on one side of part 520. Magnetic guide rings 540 may be used in conjunction with the magnetic guide vanes discussed with respect to FIGS. 2-4 above, or they may be used alone. In one embodiment, a magnetic guide ring 540 is used to control fluid flow rates upstream from one or more magnetic guide vanes. In another embodiment, an electromagnetic system may use electromagnetic fields to modulate magnetic particles to switch between forming a magnetic guide vane and a magnetic guide ring, or vice versa. Additionally, while a single magnetic ring 530 is illustrated, it is also contemplated that multiple magnetic guide rings 530 are present, in some embodiments.

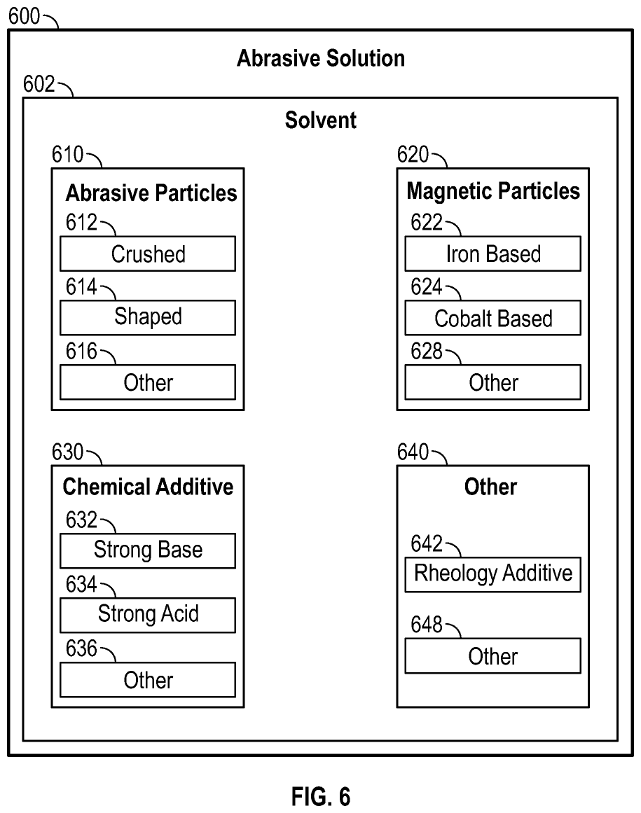

FIG. 6 illustrates an example abrasive solution in accordance with embodiments of the present invention. Abrasive solution 600 may be useful, in any of the systems described herein, or in another suitable system. Abrasive solution 600 includes a solvent 602. Solvent 602, in one embodiment, is a water-based solvent. In another embodiment, solvent 602 is an oil-based solvent such as silicone oil, mineral oil or a fluorochemical, such as a Novec™-brand engineering fluids, available from 3M Company of Minnesota, USA. However, other solvents are possible. For example, an aqueous solution that includes a rust inhibitor may also be suitable for a solution 600 with iron magnetic particles. Other solvents may also be suitable, such as ethanol, for example.

Abrasive solution 600 also includes abrasive particles 610. Abrasive particles 610 may include crushed particles 612, precisely shaped particles 614, or other particles 616 such as formed particles, platey particles, agglomerates of particles, or other suitable abrasive particles. In some embodiments, a mixture of different abrasive particle types may be used, such as both crushed 612 and precisely shaped particles 614. Different sizes of particles may also be used in different embodiments, based on the finishing operation being conducted.

As used herein, the term “shaped abrasive particle,” means an abrasive particle with at least a portion of the abrasive particle having a predetermined shape that is replicated from a mold cavity used to form the shaped precursor abrasive particle. Except in the case of abrasive shards (e.g. as described in US Patent Application Publication Nos. 2009/0169816 and 2009/0165394), the shaped abrasive particle will generally have a predetermined geometric shape that substantially replicates the mold cavity that was used to form the shaped abrasive particle. Shaped abrasive particle as used herein excludes abrasive particles obtained by a mechanical crushing operation. Suitable examples for geometric shapes having at least one vertex include polygons (including equilateral, equiangular, star-shaped, regular and irregular polygons), lens-shapes, lune-shapes, circular shapes, semicircular shapes, oval shapes, circular sectors, circular segments, drop-shapes and hypocycloids (for example super elliptical shapes).

Geometric shapes are also intended to include regular or irregular polygons or stars wherein one or more edges (parts of the perimeter of the face) can be arcuate (either of towards the inside or towards the outside, with the first alternative being preferred). Hence, for the purposes of this invention, triangular shapes also include three-sided polygons wherein one or more of the edges (parts of the perimeter of the face) can be arcuate, i.e., the definition of triangular extends to spherical triangles and the definition of quadrilaterals extends to superellipses. The second side may have (and preferably is) a second face. The second face may have a perimeter of a second geometric shape.

Shaped abrasive particles also include abrasive particles comprising faces with different shapes, for example on different faces of the abrasive particle. Some embodiments include shaped abrasive particles with different shaped opposing sides. The different shapes may include, for example, differences in surface area of two opposing sides, or different polygonal shapes of two opposing sides.

The shaped abrasive particles are typically selected to have an edge length in a range of at least about 0.001 mm, or at least about 0.01 mm, or at least about 0.1 mm, or at least about 1 mm, or longer, based on the geometry of the part to be finished.

The term “platey crushed abrasive particle”, which refers to a crushed abrasive particle resembling a platelet and/or flake that is characterized by a thickness that is less than the width and length. For example, the thickness may be less than ½, ⅓, ¼, ⅕, ⅙, 1/7, ⅛, 1/9, or even less than 1/10 of the length and/or width. Likewise, the width may be less than ½, ⅓, ¼, ⅕, ⅙, 1/7, ⅛, 1/9, or even less than 1/10 of the length.

Abrasive solution 600 also includes magnetic particles 620. Magnetic particles 620 are in suspension in abrasive solution 600, in one embodiment. Magnetic particles 620 can be a variety of sizes, such as nano iron, iron filings, as well as mixtures of different sized particles. Magnetic particles 620 are iron-based 622, in one embodiment. In another embodiment, magnetic particles 620 contain cobalt 624. However, other magnetic particles 628 may also be used, such as magnetite (Fe₃O₄), Sendust, or NdFeB powder, for example. Magnetic particles 620 may include particles coated with a layer of material, in one embodiment. In another embodiment, magnetic particles 620 are formed from substantially all magnetic material.

Abrasive solution 600 may also include a chemical additive 630. For example, finishing may be accomplished faster if a corrosive element is present. For example, a strong basic compound 632, or a strong acidic compound 634 may be present. In one embodiment, calcium hydroxide is present in the abrasive solution. However, other chemical additives 632 may also be used. In some embodiments, the chemical additive is a mineral acid (or base). Exemplary acids include: mineral acids such as, for example, hydrochloric acid, perchloric acid, sulfuric acid, nitric acid (an oxidizing acid), phosphoric acid, aqua regia; and organic acids such as, for example, oxalic acid, methanesulfonic acid, triflic acid, citric acid and acetic acid. Citric acid may be particularly useful in chemical mechanical polishing applications on an iron workpiece because it selectively attacks rust without substantially affecting an iron base. Combinations of acids and different dilutions of acids (e.g., with water) may also be used. Exemplary basic compounds include, alkali metal hydroxides, and alkali metal metasilicates. Calcium hydroxide could be used in one embodiment. Other chemical additives may also be used. In embodiments where a gas is evolved from an additive-caused reaction, a system using abrasive solution 600 may need to be able to vent or separate the evolved gas from the stream.

Abrasive solution 600 may also have other additives 640, in some embodiments. For example, it may be helpful for a particular finishing operation if abrasive solution 600 is more or less viscous than solvent 602. A rheological additive 642 may be added to change the rheology of solution 600, such as fumed silica, laponite, bentonite, organically modified clays or other suitable additives. Other additives 648 may also be present in abrasive solution 600, such as a rust inhibitor for an aqueous solution 600 with iron particles.

Abrasive solution 600 may be provided as part of a kit for finishing a metal part. In one embodiment, solvent 602 is provided as part of the kit. Abrasive particles 610 may be provided in a kit in solvent 602 or may be provided separately. Magnetic particles 620 may be provided in a kit in solvent 602 or may be provided separately. Potential additives may be provided as part of a kit, in one embodiment, as part of solvent 602 or separately. A kit may also be provided, for example, based on known temperature conditions for a finishing operation.

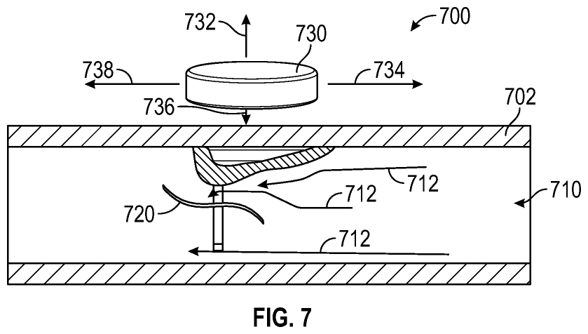

FIG. 7 illustrates an example system for modulating a magnetic guide vane in accordance with an embodiment of the present invention. Modulation of guide vane 740 may cause a flow pattern 712 of abrasive solution 710 to change around part 720. Modulation may include moving magnet 730, for example in any of directions 732-738 along the surface of pipe 702. Additionally, modulation may include moving magnet 730 closer to, or further away from vessel 702. Additionally, modulation may include tilting magnet 730 so that one edge is closer to the surface of vessel 702 than another. Modulation may cause abrasive fluid to flow differently around metal part 720, resulting in better abrading of local areas that could not be previously finished easily.

While a single magnet is illustrated in FIG. 7, it is expressly contemplated that more magnet may be present in other embodiments. Additionally, electromagnetic fields are also contemplated in other embodiments. Additionally, while part 720 is illustrated as mounted in a stationary position within a system 700, it is also contemplated that part 720 may also be moveably positioned within system 700, for example such that it can be rotated within vessel 702 so that different portions face upstream.

It is also expressly contemplated that movement of magnet 730 may be accomplished both manually, for example by a user visually monitoring the finishing operation, or by a controller. Additionally, in some embodiments, magnet 730 is controlled semi-autonomously, based on both user input and an automated routine. A controller may create a finishing routine to control movement of magnet 730 and/or part 720 based on known specifications of part 720. A user may edit the created routine, or add on to the created routine, based on how rough a part is following manufacturing for example, or based on other criteria. The routine may take into account computational fluid dynamics concerning part 720, vessel 702, and properties of abrasive solution 710 such as viscosity and solid loading, for example.

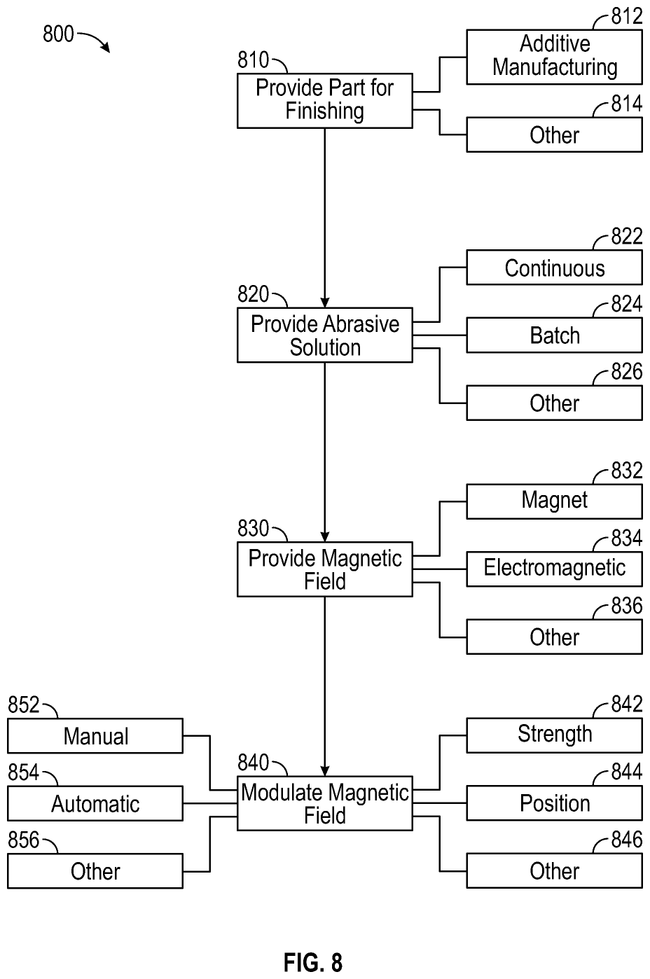

FIG. 8 illustrates a method for finishing a metal component in accordance with an embodiment of the present invention. Method 800 may be useful with any of the systems described herein, or with other suitable system.

In step 810 a part is provided for finishing. The part may be a metal part. It may be a sintered metal part or a non-sintered metal part. The part may be formed from an additive manufacturing method, as indicated in block 812, or from another method, as indicated in block 822. The part may be mounted within a finishing system, in some embodiments. The mount may maintain the part in a stationary position within a finishing vessel, in one embodiment, or may allow for part to be rotated or moved. Rotation or movement of a part within a finishing vessel may be controlled, in one embodiment, or the part may be mounted such that at least some free movement is allowed.

In step 820 an abrasive solution is provided. The abrasive solution may contain magnetic particles in suspension in addition to abrasive particles. The abrasive particles may be crushed particles, formed abrasive particles, shaped abrasive particles, platey abrasive particles or another suitable abrasive particle.

The abrasive solution may also have a chemical additive. For example, in one embodiment, an aqueous abrasive solution may contain a strong base, such as calcium hydroxide, which may have a corrosive effect on a metal part and aid in finishing. However, in another embodiment, an aqueous abrasive solution contains a strong acid. However, weak acidic or basic compounds may be useful for some embodiments.

Additionally, a rheological additive may be present, in some embodiments. For example, a higher viscosity abrasive solution may be needed for a particular finishing operation, so an additive may be provided in one embodiment that increases the viscosity of the abrasive solution.

The abrasive solution may be provided in a continuous flow operation such that it flows past, over and/or through the metal part, as indicated in block 822. In another embodiment, the abrasive solution could be provided in a batch operation, as indicated in block 824, for example in a vessel with an agitation mechanism that causes flow of the abrasive solution around a part mounted within the batch vessel. However, other configurations are also envisioned, as indicated in block 826.

In step 830, a magnetic field is provided. The magnetic field can be provided by one or more magnets placed outside a vessel, as indicated in block 832. In another embodiment, an electromagnetic field is generated, as indicated in block 834. The generated magnetic force acts on the magnetic particles within an abrasive solution, causing them to aggregate within a finishing vessel, for example along an interior surface. The aggregated magnetic particles change the flow pattern of the abrasive solution within the vessel. Controlling the position and strength of the magnetic field allows for targeted finishing of a metal part.

In step 840, the magnetic field is modulated. Modulation can include manual adjustments of a magnetic field, as indicated in block 852, for example adjusting a strength of the magnetic field, as indicated in block 842, a position of the magnetic field, as indicated in block 844, or other changes, as indicated in block 846, such as adding or removing a magnetic field source. In another embodiment, modulating includes automatically altering the magnetic field, for example by changing a strength 842, position 844, or number of magnetic field sources, such that magnetic guide vanes formed within a vessel also change, forcing an abrasive fluid flow to change. The automatic modulation may be driven, in one embodiment, by known specifications of a part being finished, for example provided by a STL file used to print the part, a CAD file related to the part, or another specification format. Modulation may continue until the part is finished, in one embodiment.

Use of method 800 may allow for surfaces of the part that would be difficult for an abrasive solution to access to be identified and targeted.

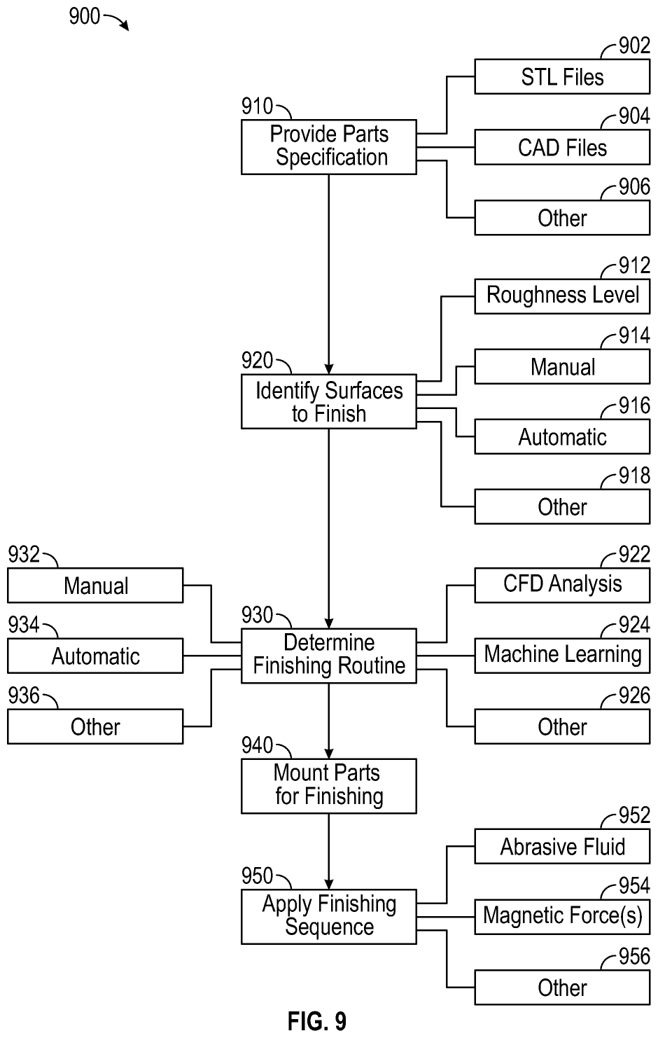

FIG. 9 illustrates another method for finishing a metal component in accordance with another embodiment of the present invention.

In step 910 part specifications are provided. For parts printed using additive manufacturing techniques, a stereolithography file (STL file) is used to provide instructions for a printer. An STL file provides a description for a triangulated surface. However, while systems and methods described herein refer to an STL file 902, other files used for additive manufacturing 906, either known now or future developed, may also be used in method 900. Additionally, any other suitable computer aided design (CAD) file 904 may also be used.

In step 920 surfaces requiring finishing are identified. Additive manufacturing, or other manufacturing techniques, can result in a part with a surface that has undesired roughness. A roughness level 912 of the part surface is identified. The part may have an even roughness across an entire surface, or may have some areas with more or less roughness. In some embodiments finishing occurs unevenly, such that rougher areas are finished without over-finishing occurring on less rough areas. Surfaces needing finishing may be identified manually, as indicated in block 914, for example by a user so indicating. However, it is also envisioned that roughness can be determined automatically, as indicated in block 916. for example by scanning a metal part and comparing it to a CAD file. Other roughness identification methods may also be used, as indicated in block 918. For example, optical measurement techniques such as laser or projected light may be used. Additionally, surface profiling may be used. An X-ray scan may also be used to determine roughness.

In step 930, a finish routine is determined. Determining a finishing routine may include retrieving a pre-set finishing routine based on an identified part, in one embodiment. In another embodiment, a finishing routine is dynamically determined based on an identified part and detected surface roughness. Determining a finishing route may include determining, based on finishing needs of a metal part, position and strength of one or more magnetic fields with respect to a finishing vessel during a finishing operation. For example, a first and second magnet may have a first and second position, at a second time at a first time and may move to a third and fourth position, respectively, at a second time such that, at the first time, a first area of a metal part is targeted for finishing and, at the second time, a second area is targeted. However, while two magnets are discussed, it is also expressly contemplated that only one magnet, or more than two magnets, may be used in different embodiments. Additionally, magnetic fields may be generated by electromagnetic systems instead of naturally magnetic material. Determining a finishing routine may also include consideration of the composition of an abrasive finishing solution. For example, an amount of magnetic material in suspension will affect the size of magnetic guide vanes that can be created. And the rheology of the abrasive solution will affect fluid flow. Additionally, a type, size and amount of abrasive particles will affect how quickly a part surface is abraded, as will the presence of a corrosive agent.

Determining a finishing routine can be done manually, as indicated in block 932, for example by a user positioning magnets to direct an abrasive fluid flow toward an area needing targeted finishing. Determining a finishing routine can also be done automatically, as indicated in block 934. Other methods can also be used, as indicated in block 936, such as a partially autonomous determination of magnet placement over time.

A finishing routine can be determined using computational fluid dynamics (CFD) analysis based on known specifications of a part, the abrasive fluid and the finishing vessel, as indicated in block 922. It may also be determined using machine learning, in some embodiments, such that a controller can adjust a finishing routine based on past changes made by a user to similar parts, as indicated in block 924. Other computer-aided methods may also be used, as indicated in block 926.

In step 940, a part is mounted for finishing. Mounting may include mounting the part in a fixed position for an entire finishing operation. In another embodiment, mounting includes moving the part with respect to a finishing vessel such that different surfaces can be more easily targeted.

In step 950, a finishing sequence is applied. The finishing sequence may include application of an abrasive fluid, as indicated in block 952. The abrasive fluid may be applied in a continuous flow, or in a batch vessel with the mounted part. The abrasive fluid may contain any or all of abrasive particles, magnetic particles, chemical or other additives. Applying the finishing sequence may also include applying a magnetic force to a finishing vessel such that magnetic particles in the abrasive fluid are agglomerated within the finishing vessel, as indicated in block 954. Applying the finishing sequence may also include other steps such as pretreatment, a cleaning rinse, adjusting a mount, changing an abrasive fluid, or other suitable steps.

Systems and methods described herein can be used for finishing metal components. Such metal components may be manufactured in a variety of ways including, but not limited to, additive manufacturing or 3D printing techniques. Additionally, while systems and methods described herein may be particularly useful for parts with internal or complex geometry, they may also be useful for other components, including those that have uneven finishing requirements. Systems and methods described herein may allow for targeted finishing of areas with a greater roughness without over-finishing areas that are less rough.

While systems described herein may be useful for accomplishing methods described herein, the methods described herein may be useful with other system configurations, in some embodiments. The methods described herein may also include other steps that are not discussed in detail. Further, while the methods are described with respect to a particular sequence, it is also contemplated that at least some steps can be accomplished in orders other than those illustrated, where appropriate.

Additionally, while the methods described herein may be useful in understanding the systems illustrated, it is also envisioned that systems may be used differently than as described in the methods. Additionally, while the systems illustrate particular components, it is also understood that more, or fewer, components may be present where appropriate.

### SELECT EMBODIMENTS OF THE PRESENT DISCLOSURE

Embodiment 1 is an abrasive solution for finishing a metal part. The abrasive solution includes abrasive particles suspended in a solution. The abrasive particles are configured to abrade a surface of the metal part. The abrasive particles are substantially non-responsive to a magnetic field. The abrasive solution also includes magnetic particles suspended in the solution. The magnetic particles configured to respond to a magnetic field by aggregating together such that a local flow pattern of the solution changes in response to the aggregated magnetic particles.
Embodiment 2 includes the features of embodiment 1, however the abrasive particles comprise crushed abrasive particles.
Embodiment 3 includes the features of embodiment 1 or 2, however the abrasive particles comprise a first set of abrasives particle and a second set of abrasive particles, and wherein the first and second sets of abrasive particles are different.
Embodiment 4 includes the features of embodiment 3, however the first and second sets of abrasive particles are different sizes.
Embodiment 5 includes the features of any of embodiments 1-4, however the abrasive particles comprise formed abrasive particles.
Embodiment 6 includes the features of any of embodiments 1-5, however the abrasive particles comprise shaped abrasive particles.
Embodiment 7 includes the features of any of embodiments 1-6, however it also includes a chemical additive.
Embodiment 8 includes the features of embodiment 7, however the chemical additive is a strong base.
Embodiment 9 includes the features of embodiment 8, however the chemical additive is an alkali metal hydroxide.
Embodiment 10 includes the features of embodiment 7, however the chemical additive is a strong acid.
Embodiment 11 includes the features of embodiment 7, however the chemical additive is a weak base.
Embodiment 12 includes the features of embodiment 7, however the chemical additive is a weak acid.
Embodiment 13 includes the features of any of embodiments 1-12, however it also includes a rheology additive.
Embodiment 14 includes the features of embodiment 13, however the rheology additive alters a viscosity of the solution.
Embodiment 15 includes the features of any of embodiments 1-14, however the solution contains water, ethanol, Novec or an oil.
Embodiment 16 includes the features of any of embodiments 1-15, however the solution is an aqueous solution.
Embodiment 17 includes the features of any of embodiments 1-15, however the solution is an oil-based solution.
Embodiment 18 includes the features of embodiment 17, however the oil comprises silicone oil or mineral oil.
Embodiment 19 includes the features of any of embodiments 1-18, however the magnetic particles are iron-based particles.
Embodiment 20 includes the features of any of embodiments 1-19, however the magnetic particles are cobalt-based particles.
Embodiment 21 includes the features of any of embodiments 1-20, however the abrasive particles have an edge length of at least about 0.001 mm.
Embodiment 22 includes the features of any of embodiments 1-21, however the abrasive particles have an edge length of at least about 0.01 mm.
Embodiment 23 includes the features of any of embodiments 1-22, however the abrasive particles have an edge length of at least about 0.1 mm.
Embodiment 24 includes the features of any of embodiments 1-23, however the abrasive solution is provided as part of a finishing kit.
Embodiment 25 is a method for finishing a 3D-printed part, the method includes providing the part in a vessel. The method also includes providing an abrasive solution to contact the part. The abrasive solution comprises abrasive particles and magnetic particles. The method also includes providing a magnetic field. The magnetic field causes the magnetic particles to agglomerate on an internal side of the vessel, forming a magnetic guide vane. The flow of the abrasive solution changes in response to the magnetic guide vane such that a first local surface of the metal part is targeted by the abrasive particles. The method also includes causing the abrasive particles to target a second local surface of the part.
Embodiment 26 includes the features of embodiment 25, however the magnetic particles are in suspension in the abrasive solution.
Embodiment 27 includes the features of any of embodiments 25-26, however the part is mounted in position within the vessel.
Embodiment 28 includes the features of any of embodiments 25-27, however the abrasive solution is provided as a continuous flow.
Embodiment 29 includes the features of any of embodiments 25-28, however the vessel is a batch vessel.
Embodiment 30 includes the features of any of embodiments 25-29, however the part is a metal part.
Embodiment 31 includes the features of any of embodiments 25-30, however the part has a rough surface.
Embodiment 32 includes the features of any of embodiments 25-31, however the part is a sintered metal part.
Embodiment 33 includes the features of any of embodiments 25-32, however the abrasive particles are crushed abrasive particles.
Embodiment 34 includes the features of any of embodiments 25-33, however the abrasive particles are precision shaped abrasive particles.
Embodiment 35 includes the features of any of embodiments 25-34, however causing the abrasive particles to target a second local surface comprises modulating the magnetic field. Modulating comprises changing a position or strength of the magnetic field.
Embodiment 36 includes the features of any of embodiments 25-35, however the magnetic field is provided by a magnet positioned external to the vessel.
Embodiment 37 includes the features of any of embodiments 25-36, however the magnetic field is provided by an electromagnet.
Embodiment 38 includes the features of any of embodiments 25-37, however the magnetic field is a first magnetic field and the magnetic guide vane is a first magnetic guide vane. The method also includes providing a second magnetic field. The second magnetic field causes the magnetic particles to agglomerate and form a second magnetic guide vane separate from the first magnetic guide vane.
Embodiment 39 includes the features of any of embodiments 25-38, however causing the abrasive particles to target the second local surface comprises manually altering a position or strength of the magnetic field.
Embodiment 40 includes the features of any of embodiments 25-39, however causing the abrasive particles to target the second local surface comprises a controller automatically changing a position or strength of the magnetic field.
Embodiment 41 includes the features of embodiment 40, however the controller changes the position or strength of the magnetic field at least in part based on a known specification of the part.
Embodiment 42 includes the features of embodiment 41, however the known specification is a CAD file related to the part.
Embodiment 43 includes the features of embodiment 41, however the known specification is an STL filed used to manufacture the part.
Embodiment 44 is a system for finishing a part with a rough surface. The system includes a vessel configured to mount the part. The system also includes an abrasive fluid configured to flow through the vessel. The abrasive fluid comprises abrasive particles configured to abrade a surface of the vessel. The abrasive fluid also comprises magnetic particles. The system also includes a magnetic field configured to act on the magnetic particles such that the magnetic particles agglomerate at a position within the vessel such that local flow of the abrasive fluid changes.
Embodiment 45 includes the features of embodiment 44, however the magnetic field is provided by a magnet located proximate the vessel.
Embodiment 46 includes the features of embodiment 45, however the magnet is located outside of the vessel, such that the magnetic particles agglomerate along an interior surface of the vessel.
Embodiment 47 includes the features of embodiment 45, however the magnetic field is provided by a first magnet at a first position and a second magnet at a second position.
Embodiment 48 includes the features of any of embodiments 44-47, however the position is a first position. The magnetic field is configured such that the magnetic particles also agglomerate at a second position.
Embodiment 49 includes the features of any of embodiments 44-48, however it also includes a controller configured to cause the magnetic field to change in strength.
Embodiment 50 includes the features of any of embodiments 44-49, however it also includes a controller configured to cause the magnetic field to change in position.
Embodiment 51 includes the features of any of embodiments 44-50, however the abrasive particles are substantially nonresponsive to a magnetic field.
Embodiment 52 includes the features of any of embodiments 44-51, however the magnetic particles comprise iron.
Embodiment 53 includes the features of any of embodiments 44-51, however the magnetic particles comprise cobalt.
Embodiment 54 includes the features of any of embodiments 44-53, however the magnetic particles and the abrasive particles are different sizes.
Embodiment 55 includes the features of any of embodiments 44-54, however the abrasive particles comprise first abrasive particles and second abrasive particles. The first abrasive particles differ from the second abrasive particles.
Embodiment 56 is a method of finishing a metal part. The method includes retrieving a specification of the metal part. The method also includes identifying a rough surface on the metal part. The method also includes determining a finishing routine for the rough surface. The method also includes mounting the metal part within a finishing vessel. The method also includes applying a finishing sequence to the metal part. The finishing sequence includes the determined finishing routing.
Embodiment 57 includes the features of embodiment 56, however the specification is a computer-aided design file.
Embodiment 58 includes the features of embodiment 57, however the specification is an STL file.
Embodiment 59 includes the features of any of embodiments 56-58, however identifying the rough surface comprises identifying a roughness level.
Embodiment 60 includes the features of any of embodiments 56-59, however the specification is automatically retrieved.
Embodiment 61 includes the features of any of embodiments 56-60, however the rough surface is automatically identified.
Embodiment 62 includes the features of any of embodiments 56-61, however the finishing routing is determined by a controller based on the retrieved specification.
Embodiment 63 includes the features of any of embodiments 56-62, however the finishing routing is determined by a controller using computational fluid dynamics and the retrieved specification.
Embodiment 64 includes the features of any of embodiments 56-63, however the finishing sequence comprises applying an abrasive fluid through the finishing vessel in a continuous flow, applying a magnetic force to the finishing vessel such that magnetic particles within the abrasive fluid agglomerate within the finishing vessel such that local flow of the abrasive fluid is targeted to a finishing area on a surface of the metal part.
Embodiment 65 includes the features of any of embodiments 56-64, however the finishing sequence comprises a cleaning rinse.
Embodiment 66 includes the features of any of embodiments 56-65, however it also includes adjusting a mount position of the metal part.
Embodiment 67 includes the features of any of embodiments 56-66, however the finishing routine comprises a first magnetic field at a first time and a second magnetic field at a second time. The first and second magnetic fields act on magnetic particles within the finishing vessel such that a first magnetic guide vane is formed by the first magnetic field, a second magnetic guide vane is formed by the second magnetic field. The first and second magnetic guide vanes are different.
Embodiment 68 includes the features of embodiment 67, however at the first time, a first surface area of the metal part is targeted for finishing. At the second time, a second surface area of the metal part is targeted for finishing.
Embodiment 69 includes the features of embodiment 67, however the first magnetic field is produced by an electromagnet.
Embodiment 70 includes the features of embodiment 67, however the first magnetic field is produced by a first magnetic field source and a second magnetic field source.
Embodiment 71 includes the features of embodiment 67, however the first magnetic field transitions to the second magnetic field between the first and second time.
Embodiment 72 includes the features of embodiment 71, however transitioning comprises moving a magnetic field source.
Embodiment 73 includes the features of embodiment 71, however transitioning comprises changing a number of magnetic field sources.

### EXAMPLES

Unless otherwise noted, all parts, percentages, ratios, etc. in the Examples and the rest of the specification are by weight.

### Example 1

Finishing of an additively manufactured part which is fixtured within a pipe through which an abrasive solution is pumped. The abrasive solution comprises 0.1 molar concentration solution of Potassium Hydroxide (KOH) in water (as sold by Sigma Aldrich, UK) with P500 semi-friable aluminium oxide, such as “BFRPL,” which is commercially available from Imerys Minerals. The weight percent of each component are shown in the table below. The iron was obtained from Sigma Aldrich. The percent of iron is dependent on the volume of the guide vanes which will be formed. There should be an excess of iron in suspension such that the iron in the system is not all consumed in the formed guide vanes.

| | % wt |
|---|---|
| KOH | 57.0% |
| P500 | 40.4% |
| Iron (325 mesh) | 2.6% |

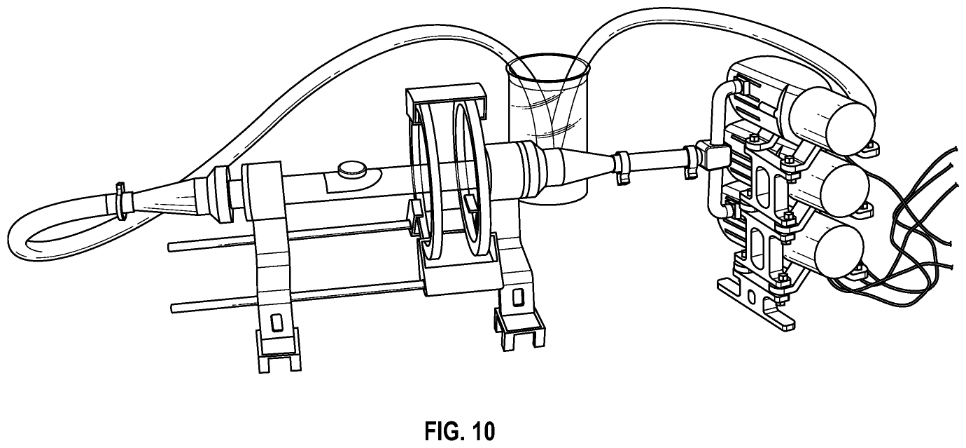

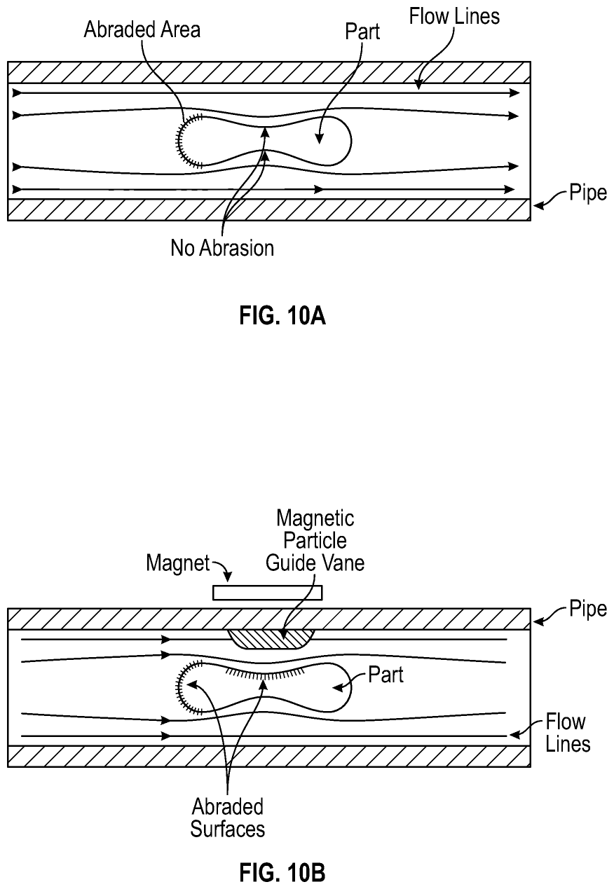

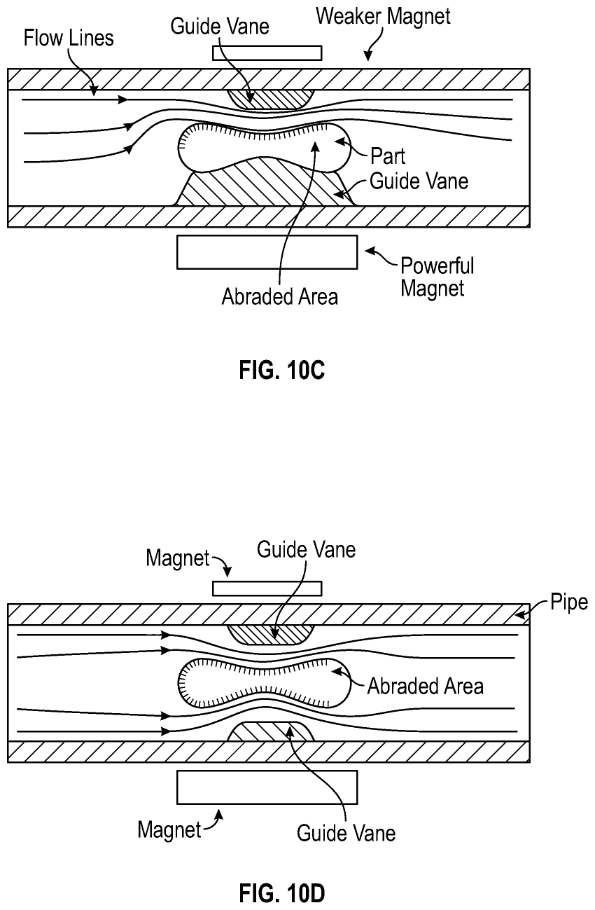

In the control case the abrasive fluid would flow around an additively manufactured part, with the flow paths and shear on surfaces defined by the external geometry of the part and orientation to the flowing abrasive fluid, using the control set up of FIG. 10. As illustrated in FIG. 10A the leading surface would be exposed to highest shear and hence this surfaced would be abraded fastest. If the concave surfaces needed finishing it would not be possible to orientate this part within a flow field to finish these areas without over finishing adjacent areas.

In FIG. 10B, a guide vane is formed to one side of the part, which will cause an asymmetric flow over the component. Positioning a magnet outside of the pipe, magnetic particles will be attracted and collect to form a guide vane, positioned to direct the abrasive fluid towards the surfaces for finishing. The magnets used were 25 mm diameter N42 NdFeB (neodymium iron boron) magnets, obtained from First4magnets.com. Where the abrasive fluid is forced to turn and shear against the part, material will be removed and the surface finish improved.

Magnets with different strengths can be used to direct all the abrasive fluid past one side of the part. In FIG. 10C placing one of the magnets on one side creates a guide vane which bridges between the part and pipe, preventing flow past this surface. The guide vane will therefore prevent this surface from being finished, directing all energy to another area. In FIG. 10C the weaker magnet on the opposite side is used to direct the fluid against the area of interest.

FIG. 10D illustrates a symmetric loading of guide vanes where the fluid is directed simultaneously to both sides of the part.

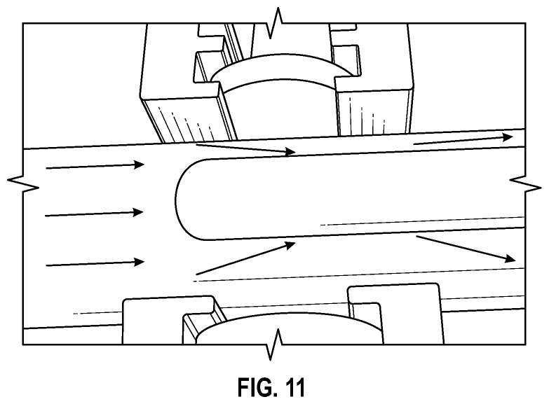

FIG. 11 illustrates flow around a part.

1. An abrasive solution for finishing a metal part, the abrasive solution comprising:
abrasive particles suspended in a solution, the abrasive particles configured to abrade a surface of the metal part, wherein the abrasive particles are substantially non-responsive to a magnetic field; and
magnetic particles suspended in the solution, the magnetic particles configured to respond to a magnetic field by aggregating together such that a local flow pattern of the solution changes in response to the aggregated magnetic particles.

2. (canceled)

3. The abrasive solution of claim 1, wherein the abrasive particles comprise a first set of abrasives particle and a second set of abrasive particles, and wherein the first and second sets of abrasive particles are different.

4. The abrasive solution of claim 3, wherein the first and second sets of abrasive particles are different sizes.

5. (canceled)

6. (canceled)

7. The abrasive solution of claim 1, and further comprising a chemical additive, wherein the chemical additive is an acidic chemical, a basic chemical, or a neutral chemical.

8. (canceled)

9. (canceled)

10-12. (canceled)

13. The abrasive solution of claim 1, and further comprising a rheology additive.

14. The abrasive solution of claim 13, wherein the rheology additive alters a viscosity of the solution.

15-18. (canceled)

19. The abrasive solution of claim 1, wherein the magnetic particles are iron-based particles.

20. The abrasive solution of claim 1, wherein the magnetic particles are cobalt-based particles.

21-23. (canceled)

24. The abrasive solution of claim 1, wherein the abrasive solution is provided as part of a finishing kit.

25. A method for finishing a 3D-printed part, the method comprising:
providing the part in a vessel;
providing an abrasive solution to contact the part, wherein the abrasive solution comprises abrasive particles and magnetic particles;
providing a magnetic field, wherein the magnetic field causes the magnetic particles to agglomerate on an internal side of the vessel, forming a magnetic guide vane, and wherein the flow of the abrasive solution changes in response to the magnetic guide vane such that a first local surface of the metal part is targeted by the abrasive particles;
causing the abrasive particles to target a second local surface of the part.

26. The method of claim 25, wherein the magnetic particles are in suspension in the abrasive solution.

27. The method of claim 25, wherein the part is mounted in position within the vessel.

28. The method of claim 25, wherein the abrasive solution is provided as a continuous flow.

29. The method of claim 25, wherein the vessel is a batch vessel.

30. The method of claim 25, wherein the part is a metal part.

31-34. (canceled)

35. The method of claim 25, wherein causing the abrasive particles to target a second local surface comprises modulating the magnetic field, wherein modulating comprises changing a position or strength of the magnetic field.

36. (canceled)

37. (canceled)

38. The method of claim 25, wherein the magnetic field is a first magnetic field and the magnetic guide vane is a first magnetic guide vane, and wherein the method also comprises:
providing a second magnetic field, wherein the second magnetic field causes the magnetic particles to agglomerate and form a second magnetic guide vane separate from the first magnetic guide vane.

39-43. (canceled)

44. A system for finishing a part with a rough surface, the system comprising:
a vessel configured to mount the part;
an abrasive fluid configured to flow through the vessel, wherein the abrasive fluid comprises abrasive particles configured to abrade a surface of the vessel, and wherein the abrasive fluid also comprises magnetic particles;
a magnetic field configured to act on the magnetic particles such that the magnetic particles agglomerate at a position within the vessel such that local flow of the abrasive fluid changes.

45. (canceled)

46. The system of claim 45, wherein the magnet is located outside of the vessel, such that the magnetic particles agglomerate along an interior surface of the vessel.

47. The system of claim 45, wherein the magnetic field is provided by a first magnet at a first position and a second magnet at a second position.

48-73. (canceled)
